(19) United States
(12) Patent Application Publication
(10) Pub. No.: US 2025/0368533 A1
(43) Pub. Date: Dec. 4, 2025

(54) METHOD FOR SYNTHESIZING BIMETALLIC SULFIDE ELECTROCATALYSTS

(71) Applicants: Muhammad Imran, Abha (SA); Muhammad Nadeem, Islamabad (PK); Arslan Hameed, Islamabad (PK); Mohammed Assiri, Abha (SA)

(72) Inventors: Muhammad Imran, Abha (SA); Muhammad Nadeem, Islamabad (PK); Arslan Hameed, Islamabad (PK); Mohammed Assiri, Abha (SA)

(21) Appl. No.: 18/732,452

(22) Filed: Jun. 3, 2024

(51) Int. Cl. C01G 51/00; H01M 4/88; H01M 4/90

(52) U.S. Cl. CPC C01G 51/82; H01M 4/8857; H01M 4/90; C01P 2006/40

(57) ABSTRACT

The present disclosure provides a method for synthesizing pentlandite-type bimetallic (Fe·Co)9S8 compounds. The method includes grinding and mixing sulfur powder with metal salts of Fe and Co to form a homogeneous mixture, and conducting solid-state pyrolysis of the mixture at a temperature of 900° C. in an Argon atmosphere. The synthesized (Fe·Co)₉S₈ compound can be used as electrode material in electrochemical processes. In some embodiments, the method further includes dispersing the synthesized (Fe·Co)₉S₈ in a Nafion and isopropanol mixture to form a suspension, and coating the suspension on a glassy carbon electrode to form an electrode comprising (Fe·Co)₉S₈ pentlandite. The method provides a streamlined approach to synthesizing (Fe·Co)₉S₈ pentlandite, a material with potential applications in renewable energy technologies including electrocatalyst for OER in water splitting for hydrogen production.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of electrocatalysis and materials science, and more specifically to the synthesis of bimetallic sulfide electrocatalysts, particularly (Fe·Co)₉S₈ pentlandite, through a one-step solid-state pyrolysis method.

### 2) Description of Related Art

The field of electrocatalysis and materials science has seen a surge in research and development efforts, particularly in the area of water splitting reactions such as the oxygen evolution reaction (OER). This is largely due to the increasing demand for sustainable and renewable energy sources as an alternative to fossil fuels. The OER is a half-reaction that plays a pivotal role in water electrolysis, a process that is integral to the production of hydrogen, a clean and renewable energy source.

Noble metals such as platinum (Pt) and iridium (Ir) are often used as electrocatalysts in water splitting reactions due to their high catalytic activity. However, the scarcity and high cost of these noble metals make them less feasible for large-scale applications. As a result, there has been a shift towards the use of non-noble and non-precious metals such as iron and cobalt, which are more abundant and cost-effective.

These non-noble metals are typically used in the form of various compounds, including metallic oxides, hydroxides, phosphides, and chalcogenides. The electrocatalytic efficiency of these metals can be further enhanced by using them in bimetallic or trimetallic configurations.

Among the various types of metal sulfide-based chalcogenides, pentlandite-like Co₉S₈ has been shown to exhibit high efficiency towards the OER under alkaline conditions. This is primarily due to its pseudo-metallic electronic structure, next nearest neighbor metal-metal bond, and suitable adsorption for intermediates. Bimetallic pentlandites such as (FeₓNi₁₋ₓ)₉S₈ and Ni_{4.3}Co_{4.7}S₈ have also been reported to show considerable catalytic efficiency for the OER, further emphasizing the potential of these materials in the field of electrocatalysis.

In the synthesis of these materials, a variety of methods can be employed, including solid-state pyrolysis. This method involves the heating of a material in the absence of oxygen to induce chemical reactions. Characterization techniques such as powder X-ray diffraction (p-XRD), X-ray photoelectron spectroscopy (XPS), high-resolution scanning electron microscopy (SEM), and transmission electron microscopy (TEM) are often used to verify the accuracy and effectiveness of the synthesis process. Electrochemical studies are also conducted to evaluate the performance of the synthesized material as an electrode for the OER.

### BRIEF SUMMARY OF THE INVENTION

The instant invention in one form is directed to a method for synthesizing pentlandite-type bimetallic (Fe·Co)₉S₈, comprising: grinding and mixing sulfur powder with metal salts of Fe and Co to form a homogeneous mixture; and conducting solid state pyrolysis of the homogeneous mixture at a temperature of 900° C. in an inert atmosphere to obtain pentlandite-type (Fe·Co)₉S₈.

In some aspects, the sulfur powder, and the metal salts of Fe and Co have a purity greater than 99.9%. In some aspects, the metal salts of Fe and Co are mixed in an equimolar ratio. In some aspects, the metal salts of Fe and Co include iron nitrate (Fe(NO₃)₃·9H₂O) and cobalt nitrate (Co(NO₃)₂·6H₂O) respectively. In some aspects, the 53.1 mmol of sulfur are ground and mixed together with 29.8 mmol of Fe(NO₃)₃·9H₂O and 29.8 mmol of (Co(NO₃)₂·6H₂O) to obtain the homogeneous mixture.

In some aspects, the metal salts of Fe and Co are a chloride salt or an acetate salt. In some aspects, the solid-state pyrolysis in performed in a furnace wherein the inert gas is Argon. In some aspects, the solid-state pyrolysis in performed in a furnace with controlled temperature ramping rate of 5° C. min⁻¹ until a temperature of 900° C. is achieved. In some aspects, the solid-state pyrolysis is performed for 10 hours.

The instant invention in another form is directed to a method for synthesizing bimetallic (Fe·Co)₉S₈ pentlandite, comprising: grinding and mixing sulfur powder with Fe(NO₃)₃·9H₂O and Co(NO₃)₂·6H₂O until a homogeneous mixture is formed; and conducting a thermal treatment of the homogeneous mixture in a furnace at a temperature of 900° C. under Argon flow for 10 h to obtain the (Fe·Co)₉S₈ pentlandite.

In some aspects, 53.1 mmol of sulfur are ground and mixed together with 29.8 mmol of Fe(NO3)3·9H2O and 29.8 mmol of (Co(NO₃)₂·6H₂O) to obtain the homogeneous mixture. In some embodiments, the grinding and mixing of sulfur powder with Fe (NO3)3·9H2O and (Co(NO₃)₂·6H₂O) and sulfur is performed in a ball mill.

In some aspects, the solid-state pyrolysis is performed in a furnace with controlled temperature ramping rate of 5° C. min-1 until a temperature of 900° C. is achieved. In some aspects, the grinding and mixing of Fe(NO₃)₃·9H₂O, Co(NO₃)₂·6H₂O and sulfur is performed using a mechanical mixer at a speed of 500 rpm. In some aspects, the solid-state pyrolysis is performed in a furnace, wherein the homogenous mixture is loaded in a porcelain alumina boat to avoid contamination.

The instant invention in another form is directed to a method for synthesizing an electrode comprising bimetallic (Fe·Co)₉S₈ pentlandite, the method comprising: grinding and mixing sulfur powder with metal salts of Fe and Co to form a homogeneous mixture; conducting solid state pyrolysis of the homogeneous mixture at a temperature of 900° C. for 10 hours to obtain the (Fe·Co)₉S₈ pentlandite; and dispersing the (Fe·Co)₉S₈ pentlandite in a Nafion and isopropanol mixture to form a suspension; coating the suspension on a glassy carbon electrode to form an electrode comprising (Fe·Co)₉S₈ pentlandite.

In some aspects, the metal salts of Fe and Co include iron nitrate (Fe(NO₃)₃·9H₂O) and cobalt nitrate (Co(NO₃)₂·6H₂O) mixed in an equimolar ratio. In some aspects, the grinding and mixing of sulfur powder with Fe(NO₃)₃·9H₂O and Co(NO₃)₂·6H₂O is performed in a ball mill.

In some aspects, the Nafion and isopropanol mixture comprises 10% Nafion and the remainder being isopropanol. In some aspects, dispersing the (Fe·Co)₉S₈ pentlandite in a Nafion and isopropanol mixture is performed using a sonicator operates at a power of 100 W and a frequency of about 42 kHz. In some aspects, coating the suspension on a glassy carbon electrode is performed by at least one of drop casting, dip coating, or spray coating.

According to an aspect of the present disclosure, a method of forming bimetallic (Fe·Co)₉S₈ pentlandite-type compound includes the steps of grinding and mixing high-purity metal salts and sulfur powder until a homogeneous mixture is formed. This mixture is then transferred to a porcelain alumina boat. The product undergoes solid state pyrolysis at 900° C. to obtain the (Fe·Co)₉S₈ pentlandite. The (Fe·Co)₉S₈ is then dispersed in a mixture of Nafion and isopropanol and spray coated. The electrochemical activity of (Fe·Co)₉S₈ towards oxygen evolution reaction is then measured.

According to other aspects of the present disclosure, the method may include the mixing of Fe(NO₃)₃·9H₂O (1.67 g, 29.8 mmol), Co(NO₃)₂·6H₂O (1.75 g, 29.8 mmol) and sulfur (1.70 g, 53.1 mmol) during the solid-state pyrolysis. The step of transferring the homogenous mixture to a porcelain tube may involve the transfer of iron nitrate, cobalt nitrate and sulfur powder as a source of sulfur to the porcelain alumina boat. The solid-state pyrolysis of the homogeneous mixture may involve the pyrolysis of iron nitrate, cobalt nitrate and sulfur powder at 900° C. with ramping of 5° C. min⁻¹ for 10 h. The step of dispersing the (Fe·Co)₉S₈ may comprise the use of isopropanol and 5% Nafion mixture (100 μL) in a sonicator with a 100 W power output and about 42 kHz of frequency. The measurement of electrochemical activity of (Fe·Co)₉S₈ may involve the use of a three electrode cell with a graphite rod as counter electrode, Hg/HgO as reference electrode and (Fe·Co)₉S₈ coated glassy carbon as working electrode and measurement of electrochemical activity in 1 M KOH by using an electrochemical workstation.

The foregoing general description of the illustrative embodiments and the following detailed description thereof are merely exemplary aspects of the teachings of this disclosure and are not restrictive.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a process flow diagram of a method of synthesis of pentlandite-type (Fe·Co)₉S₈ material, according to an embodiment;

FIG. 2 is a process flow diagram of a method of synthesis of pentlandite-type (Fe·Co)₉S₈ electrode, according to an embodiment;

FIG. 3 is an electrode comprising a coating of a pentlandite-type (Fe·Co)₉S₈ material, according to an embodiment; and

FIG. 4 is an electrochemical cell comprising a pentlandite-type (Fe·Co)₉S₈ coated electrode for water electrolysis, according to an embodiment.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms pentlandite and pentlandite-type are used interchangeably to mean a pentlandite-type phase of (Fe·Co)₉S₈ synthesized according to various embodiments of the instant invention.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure pertains to a method for synthesizing bimetallic (Fe·Co)₉S₈ pentlandite, a compound with potential applications in various fields, including electrocatalysis. Specifically, the method may involve a one-step solid pyrolysis synthesis, which may offer a simplified and efficient approach to producing this compound. The method may also include subsequent steps such as dispersing the synthesized compound in a specific mixture and measuring its electrochemical activity towards the oxygen evolution reaction, a process of interest in the field of water splitting to produce hydrogen. In some aspects the catalyst may be used for hydrogen evolution reaction in water splitting. In some aspects, the catalyst may be used of oxygen reduction reaction in fuel cells.

In some aspects, the method of forming (Fe·Co)₉S₈ pentlandite may involve grinding and mixing high-purity metal salts and sulfur powder until a homogeneous mixture is formed. This mixture may then be transferred to a porcelain alumina boat for solid state pyrolysis at a specific temperature. The resulting product, (Fe·Co)₉S₈ pentlandite, may then be dispersed in a Nafion and isopropanol mixture. The electrochemical activity of the compound towards the oxygen evolution reaction may then be measured, providing valuable information about its potential as an electrocatalyst.

The disclosed method may offer several potential benefits. For instance, the one-step solid pyrolysis synthesis may simplify the production process of (Fe·Co)₉S₈ pentlandite, potentially reducing the time, cost, and complexity associated with its formation. Additionally, the method may allow for precise control over the composition and properties of the synthesized compound, which may be beneficial in optimizing its performance as an electrocatalyst.

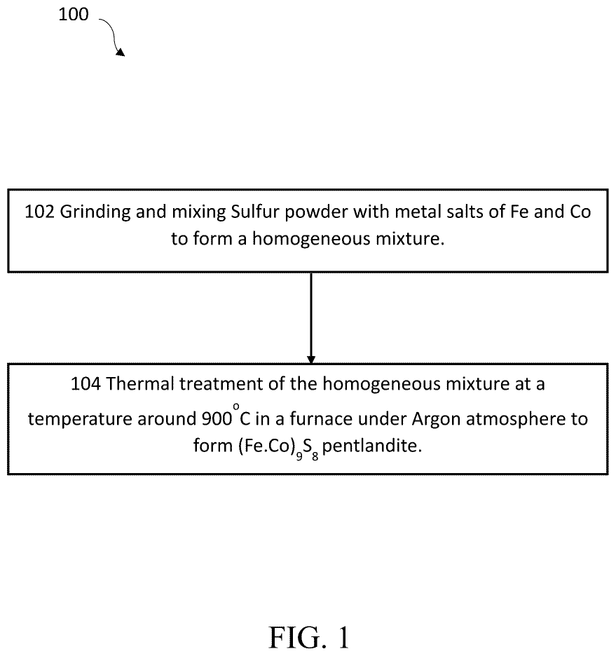

FIG. 1 shows a process flow diagram of a method of synthesis of pentlandite-type (Fe·Co)₉S₈ material. The method involves a step 202 where 202 grinding and mixing Sulfur powder with metal salts of Fe and Co is performed to form a homogeneous mixture. This is followed by step 204 where Thermal Treatment of the homogeneous mixture in a furnace at a temperature around 900° C. under Argon atmosphere to form pentlandite type (Fe·Co)₉S₈ catalyst material.

In some aspects, process may involve the use of specific metal salts, such as iron nitrate Fe(NO₃)₃·9H₂O and cobalt nitrate (Co(NO₃)₂·6H₂O) and sulfur powder. The grinding and mixing process may continue until a homogeneous mixture is formed. The formation of a homogeneous mixture may ensure that the metal salts and sulfur are evenly distributed throughout the mixture, which may contribute to the uniformity and consistency of the resulting (Fe·Co)₉S₈ pentlandite.

In some aspects, the grinding and mixing of sulfur powder with metal salts of Fe and Co may be performed in a ball mill. The ball mill may provide a high-energy mechanical force that facilitates the thorough mixing of the sulfur powder with the metal salts. This may result in a homogeneous mixture, which is a prerequisite for the successful synthesis of the pentlandite-type (Fe·Co)₉S₈ compound. The use of a ball mill may also allow for the control of the particle size of the mixture, which may influence the properties of the resulting compound.

The ball mill may operate at a specific speed and for a specific duration to ensure a thorough mixing of the sulfur powder with the metal salts. For example, the ball mill may operate at a speed in the range between about 500 rpm and about 5000 rpm for a duration between about 15 mins and about 3 hours. This specific speed and duration may be chosen to optimize the grinding and mixing process, leading to a homogeneous mixture of sulfur powder and metal salts. However, the exact speed and duration of the ball mill operation may be adjusted based on factors such as the specific properties of the sulfur powder and the metal salts, the desired particle size of the mixture, and the specific characteristics of the ball mill.

In some aspects, the ball mill may be equipped with specific features to facilitate the grinding and mixing process. For instance, the ball mill may include a grinding chamber, a number of grinding balls, and a motor to drive the grinding balls. The grinding chamber may be designed to accommodate the sulfur powder and the metal salts, and the grinding balls may be designed to grind and mix the sulfur powder and the metal salts when driven by the motor. The specific design and operation of the ball mill may contribute to the formation of a homogeneous mixture of sulfur powder and metal salts, which is a prerequisite for the successful synthesis of the pentlandite-type (Fe·Co)₉S₈ compound.

In some aspects, the process of grinding and mixing of the sulfur powder with the metal salts of Fe and Co can be performed in a mechanical mixer. In some aspects, the mechanical mixing is performed at a speed around 500 rpm. In some aspects, the mechanical mixing is performed at a speed between about 300 rpm and about 2000 rpm. In some aspects, the mechanical mixing is performed at a speed between about 300 rpm and about 600 rpm. In some aspects, the mechanical mixing is performed at a speed between about 600 rpm and about 1000 rpm. In some aspects, the mechanical mixing is performed at a speed between about 1000 rpm and about 2000 rpm.

In some embodiments, the mechanical mixing is performed for 2 hours. In some embodiments, the mechanical mixing is performed for a time between about 10 mins and 2 hours. In some embodiments, the mechanical mixing is performed for a time between about 10 mins and about 30 mins. In some embodiments, the mechanical mixing is performed for a time between about 30 mins and about 1 hour. In some embodiments, the mechanical mixing is performed for a time between about 1 hour and about 2 hours.

The sulfur powder and the metal salts of Fe and Co used in the method are chosen to have high purity. In some aspects, the purity of sulfur powder and the metal salts of Fe and Co used in the method greater than 99.9%. In some aspects, the purity of sulfur powder and the metal salts of Fe and Co used in the method is in the range between about 99.9% and about 99.9999%. In some aspects, the purity of sulfur powder and the metal salts of Fe and Co used in the method is in the range between about 99.99% and about 99.9999%. In some aspects, the purity of sulfur powder and the metal salts of Fe and Co used in the method is in the range between about 99.999% and about 99.9999%.

In some cases, the metal salts of Fe and Co may be mixed in an equimolar ratio. This balanced proportion of the two metals in the mixture may facilitate the formation of the pentlandite-type (Fe·Co)₉S₈ compound, as it may provide an equal number of Fe and Co atoms for the chemical reactions during the solid-state pyrolysis. In some aspects, sulfur is ground and mixed together with iron salt and cobalt salt in a stoichiometric molar ratio of 1.78:1:1 to obtain the homogeneous mixture

In some aspects, sulfur is ground and mixed together with iron nitrate and cobalt nitrate in a stoichiometric molar ratio of 1.78:1:1 to obtain the homogeneous mixture. In an exemplary embodiment, the quantities may be 1.67 g (29.8 mmol) of Fe(NO₃)₃·9H₂O, 1.75 g (29.8 mmol) of Co(NO₃)₂·6H₂O, and 1.70 g (53.1 mmol) of sulfur. The use of these specific quantities may be based on stoichiometric considerations and may contribute to the formation of (Fe·Co)₉S₈ pentlandite with a desired composition and properties. However, it is to be understood that other quantities of these components may also be used, depending on the specific requirements of the synthesis process and the desired properties of the resulting (Fe·Co)₉S₈ pentlandite.

In some embodiments, the metal salts of Fe and Co may include iron nitrate Fe(NO₃)₃·9H₂O and cobalt nitrate (Co(NO₃)₂·6H₂O) respectively. These specific salts may be chosen due to their reactivity and availability. However, other salts of Fe and Co, such as chloride or acetate salts, may also be used in other embodiments. In one exemplary embodiment, ferric acetate and cobalt acetate are used instead of ferric nitrate and cobalt nitrate.

Once the homogeneous mixture is formed, it may undergo solid-state pyrolysis. This process may involve heating the mixture in a furnace at a temperature of 900° C. in an inert atmosphere, such as an argon atmosphere, to induce the desired chemical reactions between the sulfur and the metal salts. This may result in the formation of the pentlandite-type (Fe·Co)₉S₈ compound.

In some aspects, the homogeneous mixture in transferred to the furnace in a porcelain alumina boat. This boat may serve as a suitable container for the subsequent solid state pyrolysis process. This process may be an integral part of the method of forming (Fe·Co)₉S₈ pentlandite The transfer process may be carried out with care to ensure that the homogeneous mixture is evenly distributed within the porcelain alumina boat. This even distribution may contribute to the uniform heating of the mixture during the pyrolysis process, which may in turn enhance the consistency and quality of the resulting (Fe·Co)₉S₈ pentlandite.

The use of iron nitrate, cobalt nitrate, and sulfur powder as a source of sulfur may also contribute to the formation of (Fe·Co)₉S₈ pentlandite with a desired composition and properties. In some aspects, the use of a porcelain alumina boat is preferred to ensure that there is no contamination of another chemical species which may disrupt the chemical reaction or the formation of the specific pentlandite phase, or lead to chemical impurities that may affect the electrocatalytic performance of the (Fe·Co)₉S₈ pentlandite.

In some aspects, the transfer process may be performed manually or with the aid of suitable tools or equipment. The specific method of transfer may depend on various factors, such as the size and shape of the porcelain alumina boat, the quantity of the homogeneous mixture, and the specific requirements of the synthesis process. Regardless of the specific method of transfer, the goal may be to ensure that the homogeneous mixture is properly positioned within the porcelain alumina boat for the subsequent solid state pyrolysis process without any contamination.

In some cases, the porcelain alumina boat containing the homogeneous mixture may then be placed in a suitable furnace or oven for the solid-state pyrolysis process. The furnace or oven may be preheated to a specific temperature, such as 900° C., to facilitate the pyrolysis process. The porcelain alumina boat may be positioned within the furnace or oven in a manner that allows for uniform heating of the homogeneous mixture. This uniform heating may contribute to the formation of (Fe·Co)₉S₈ pentlandite with a desired composition and properties.

In some aspects, the transfer of the homogeneous mixture to the porcelain alumina boat and the subsequent solid state pyrolysis process may be performed under controlled conditions to ensure the quality and consistency of the resulting (Fe·Co)₉S₈ pentlandite. These controlled conditions may include, for example, a specific temperature, pressure, and atmosphere. The specific conditions may be selected based on the specific requirements of the synthesis process and the desired properties of the resulting (Fe·Co)₉S₈ pentlandite.

In some aspects, the solid-state pyrolysis process may involve the pyrolysis of iron nitrate, cobalt nitrate, and sulfur powder at a specific temperature, such as 900° C. This temperature may be selected to facilitate the formation of (Fe·Co)₉S₈ pentlandite from the mixture of these components. The pyrolysis process may involve heating the mixture at this temperature for a specific duration, which may be, for example, 10 hours. This duration may be selected based on the specific requirements of the synthesis process and the desired properties of the resulting (Fe·Co)₉S₈ pentlandite.

In some aspects, the solid-state pyrolysis is performed for a time greater than 10 hours. In some aspects, the solid-state pyrolysis is performed for a time between about 10 hours and about 24 hours. In some aspects, the solid-state pyrolysis is performed for a time between about 10 hours and about 15 hours. In some aspects, the solid-state pyrolysis is performed for a time between about 15 hours and about 20 hours. In some aspects, the solid-state pyrolysis is performed for a time between about 10 hours and about 24 hours. In some aspects, the solid-state pyrolysis is done for a time sufficient to ensure the formation of (Fe·Co)₉S₈ pentlandite phase. In some aspects, the time of thermal treatment is optimized iteratively by performing the pyrolysis for a specific amount of time and then performing materials characterization to check whether (Fe·Co)₉S₈ pentlandite phase is formed.

In some aspects, the solid-state pyrolysis process may be performed in a suitable furnace or oven, which may be capable of maintaining a specific temperature and ramping rate. The furnace or oven may also be capable of providing a controlled atmosphere, which may be beneficial in preventing unwanted reactions or the formation of by-products during the pyrolysis process. The specific type and design of the furnace or oven may depend on various factors, such as the specific requirements of the synthesis process, the quantity of the homogeneous mixture, and the desired properties of the resulting (Fe·Co)₉S₈ pentlandite.

In an exemplary embodiment, the thermal treatment of the mixture during the pyrolysis process may involve a ramping of 5° C. min⁻¹. This ramping rate may be selected to ensure a gradual and controlled increase in temperature, which may contribute to the formation of (Fe·Co)₉S₈ pentlandite with a desired composition and properties. The use of a specific ramping rate may also help to prevent rapid or uneven heating of the mixture, which could potentially lead to the formation of unwanted by-products or inconsistencies in the resulting (Fe·Co)₉S₈ pentlandite.

The resulting (Fe·Co)₉S₈ pentlandite may then be collected from the porcelain alumina boat and subjected to further processing or analysis. For instance, the (Fe·Co)₉S₈ pentlandite may be dispersed in a Nafion and isopropanol mixture, coated on a glassy carbon electrode to prepare an electrocatalytic electrode, and its electrochemical activity towards the oxygen evolution reaction may be measured. These subsequent steps may provide valuable information about the performance of the synthesized (Fe·Co)₉S₈ pentlandite as an electrocatalyst.

Material characterization of synthesized (Fe·Co)₉S₈ Pentlandite may be performed to analyze its various attributes which may be useful in further optimization of the synthesis process. In one exemplary embodiment, the synthesized (Fe·Co)₉S₈ pentlandite synthesized using process 102 underwent a comprehensive material characterization to assess its structural and elemental attributes. XRD analysis involved obtaining the XRD pattern to validate the crystalline structure, comparing observed peaks with the simulated pattern of pentlandite (JCPDS #01-086-2273). SEM and TEM analysis were employed to investigate the material's morphology, revealing nanostructured (Fe·Co)₉S₈ pentlandite with distinctive porous features. XPS analysis confirmed the oxidation states of Fe, Co, and S, providing evidence of the successful synthesis of pentlandite. Additionally, EDX elemental mapping demonstrated the uniform dispersion of Fe, Co, and S throughout the material, emphasizing its compositional homogeneity. This collective characterization illuminates the synthesized (Fe·Co)₉S₈ pentlandite's key structural and elemental properties.

In some embodiments, the (Fe·Co)₉S₈ pentlandite is nanostructured with particle size in the range between about 10 nm and 500 nm. In some aspects, the nanoscale particle size of the pentlandite (Fe·Co)₉S₈ enhances the electrocatalytic performance. In some embodiments, the particle size of pentlandite (Fe·Co)₉S₈ is in the range between about 5 nm and 200 nm. In some embodiments, the particle size of pentlandite (Fe·Co)₉S₈ is in the range between about 5 nm and 20 nm. In some embodiments, the particle size of pentlandite (Fe·Co)₉S₈ is in the range between about 20 nm and 50 nm. In some embodiments, the particle size of pentlandite (Fe·Co)₉S₈ is in the range between about 50 nm and 100 nm. In some embodiments, the particle size of pentlandite (Fe·Co)₉S₈ is in the range between about 100 nm and 200 nm. In some embodiments, the particle size of pentlandite (Fe·Co)₉S₈ is in the range between about 200 nm and 500 nm.

In some embodiments, the pentlandite (Fe·Co)₉S₈ synthesized using the process described in this disclosure is porous. In some embodiments, the pentlandite (Fe·Co)₉S₈ has porosity between about 5% and 70%. In some embodiments, the pore sizes in the coating are between about 10 nm and about 100 nm. In some embodiments, the porosity enhances the electrocatalytic performance of the pentlandite by providing high surface area for the electron transfer processes.

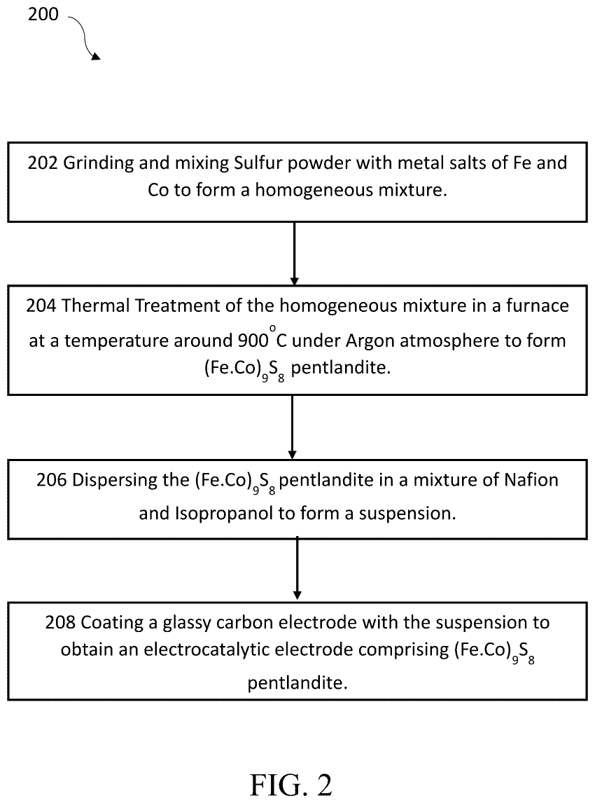

FIG. 2 shows a process flow diagram of a method of synthesis of pentlandite-type (Fe·Co)₉S₈ electrode. The steps 202 and 204 are identical to steps 102 and 104 respectively, as described in previous sections of this disclosure. Once the (Fe·Co)₉S₈ pentlandite is synthesized by thermal treatment, it is dispersed in step 206 in a mixture of Nafion and Isopropanol to form a suspension. Subsequently, in step 208, an electrocatalytic electrode comprising (Fe·Co)₉S₈ catalyst material is obtained by coating a glassy carbon electrode with the suspension.

In some aspects, the step 206 of dispersion of the (Fe·Co)₉S₈ pentlandite in the Nafion and isopropanol mixture may involve the use of a sonicator. The sonicator may operate at a power output of about 100 W and a frequency of about 42 kHz. These specific operating conditions may be selected to ensure effective dispersion of the (Fe·Co)₉S₈ pentlandite in the mixture. The sonicator may generate high-frequency sound waves that agitate the mixture, facilitating the dispersion of the (Fe·Co)₉S₈ pentlandite.

In some cases, the dispersion process may involve the use of a specific volume of the Nafion and isopropanol mixture. For instance, the volume may be 100 μL, which may include 5% Nafion and the remainder being isopropanol. This specific volume and composition of the mixture may be selected to ensure effective dispersion of the (Fe·Co)₉S₈ pentlandite and to facilitate subsequent electrochemical measurements. However, it is to be understood that other volumes and compositions of the Nafion and isopropanol mixture may also be used, depending on the specific requirements of the dispersion process and the desired properties of the resulting dispersion.

In some aspects, the dispersion of the (Fe·Co)₉S₈ pentlandite in the Nafion and isopropanol mixture may be performed under controlled conditions to ensure the quality and consistency of the resulting dispersion. These controlled conditions may include, for example, a specific temperature, pressure, and sonication duration. The specific conditions may be selected based on the specific requirements of the dispersion process and the desired properties of the resulting dispersion.

The coating of the suspension on the glassy carbon electrode may be performed by various methods, such as drop casting, dip coating, or spray coating. The choice of coating method may depend on factors such as the specific properties of the suspension, the desired thickness of the coating, and the specific characteristics of the glassy carbon electrode.

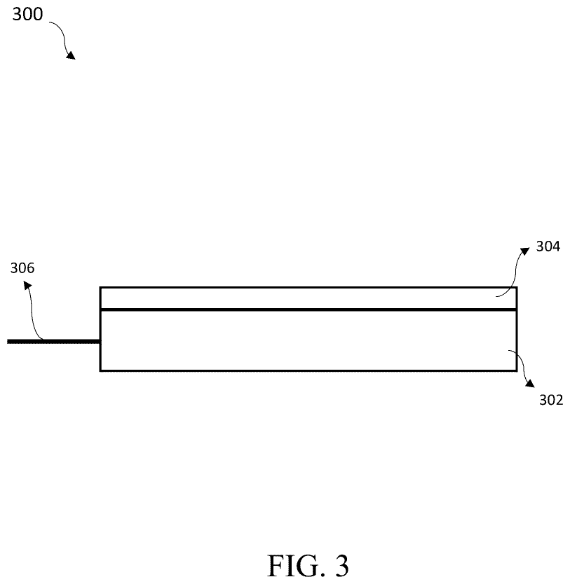

FIG. 3 shows an electrode 300 comprising a coating of a pentlandite-type (Fe·Co)₉S₈ material fabricated by the process described in FIG. 2. As shown, the electrode comprises a glassy carbon electrode 302 acting as a substrate on which a coating 304 of pentlandite (Fe·Co)₉S₈ pentlandite is deposited using the methods described before. The glassy carbon electrode is connected to a metallic connector or metallic wire 306. The coating 304 has continuous coverage or partial coverage on the glassy carbon electrode 302.

In some aspects, the (Fe·Co)₉S₈ pentlandite coated onto the glassy carbon electrode, which may serve as the working electrode in an electrochemical cell or an electrolytic electrode for OER in a water splitting electrochemical cell. The coating of the (Fe·Co)₉S₈ pentlandite onto the glassy carbon electrode may involve the use of a suitable binder, such as Nafion, to ensure a uniform and stable coating. The glassy carbon electrode may be selected for its high conductivity and chemical stability, which may contribute to the accuracy and reliability of the electrochemical measurements.

In some embodiments, the coating 304 has thickness in the range between about 10 nm and about 2000 nm. In some embodiments, the coating 304 has thickness in the range between about 10 nm and 50 nm. In some embodiments, the coating 304 has thickness in the range between about 50 nm and 100 nm. In some embodiments, the coating 304 has thickness in the range between about 100 nm and 200 nm. In some embodiments, the coating 304 has thickness in the range between about 200 nm and 500 nm. In some embodiments, the coating 304 has thickness in the range between about 500 nm and 1000 nm. In some embodiments, the coating 304 has thickness in the range between about 1000 nm and 2000 nm.

In some embodiments the coating 304 is nanostructured meaning the grains of the pentlandite (Fe·Co)₉S₈ in the coating have a nanoscale grain size. In some aspects, the nanoscale grain size of the pentlandite (Fe·Co)₉S₈ enhances the electrocatalytic performance of the electrode. In some embodiments, the grain size of pentlandite (Fe·Co)₉S₈ in the coating is between about 5 nm and 200 nm. In some embodiments, the grain size of pentlandite (Fe·Co)₉S₈ in the coating is between about 5 nm and 20 nm. In some embodiments, the grain size of pentlandite (Fe·Co)₉S₈ in the coating is between about 20 nm and 50 nm. In some embodiments, the grain size of pentlandite (Fe·Co)₉S₈ in the coating is between about 50 nm and 100 nm. In some embodiments, the grain size of pentlandite (Fe·Co)₉S₈ in the coating is between about 100 nm and 200 nm.

In some embodiments, the coating is porous. In some embodiments, the coating has porosity between about 5% and 60%. In some embodiments, the pore sizes in the coating are between about 10 nm and about 100 nm. In some embodiments, the porosity enhances the electrocatalytic performance of the pentlandite. In some embodiments the electrocatalytic performance is due to synergistic catalysis at the interface of glassy carbon with pentlandite.

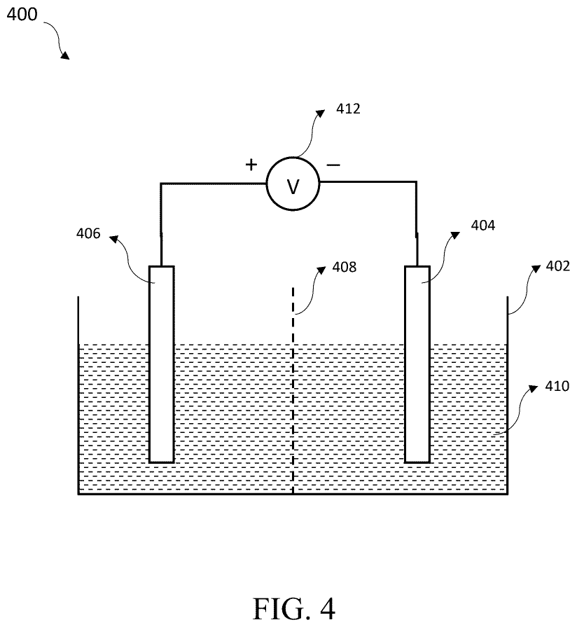

FIG. 4 shows an electrochemical system 400 comprising a pentlandite-type (Fe·Co)₉S₈ coated electrode for water electrolysis. The electrochemical cell or an electrolyzer for water splitting 402 comprises a cathode 404, an anode 406, a separator 408, and the electrochemical cell is filled with electrolyte 410. The cathode 404 is an electrocatalytic electrode (acting as the OER electrode in water splitting) comprising (Fe·Co)₉S₈ pentlandite coated on a glassy carbon electrode which has been described in detail in previous sections. The anode 406 is also an electrocatalytic electrode (where hydrogen is released in water splitting) comprising a catalytic material to catalyze the reaction at the anode. The separator 408 can be a membrane separator as used in the art. The electrolyte 410 comprises water and an alkali (KOH, NaOH), the latter facilitating the rate of the reaction. The power source 412 is the DC power source used to apply the require voltage V (as shown) for the electrochemical reaction. In some aspects the anode 406 also has a coating of (Fe·Co)₉S₈ pentlandite.

In some aspects, the electrochemical cell 400 may be used for measuring the electrochemical activity of the (Fe·Co)₉S₈ pentlandite towards the oxygen evolution reaction. This measurement may provide valuable information about the performance of the (Fe·Co)₉S₈ pentlandite as an electrocatalyst. The measurement of electrochemical activity may involve the use of a three-electrode cell, which may include a graphite rod as a counter electrode, a Hg/HgO as a reference electrode, and a (Fe·Co)₉S₈ coated glassy carbon as a working electrode.

In some aspects, the three-electrode cell may be used in conjunction with an electrochemical workstation for the measurement of the performance of (Fe·Co)₉S₈ pentlandite as an electrocatalyst. The electrochemical workstation may be capable of measuring the electrochemical activity of the (Fe·Co)₉S₈ pentlandite in a controlled environment, such as in 1 M KOH. This controlled environment may be selected to mimic the conditions under which the (Fe·Co)₉S₈ pentlandite may be used as an electrocatalyst, thereby providing a realistic assessment of its performance.

In some aspects, the graphite rod may serve as a counter electrode in the three-electrode cell. The graphite rod may be selected for its high conductivity and chemical stability, which may contribute to the accuracy and reliability of the electrochemical measurements. The Hg/HgO may serve as a reference electrode, providing a stable and reproducible reference potential against which the potential of the working electrode may be measured.

In some aspects, the measurement of the electrochemical activity of the (Fe·Co)₉S₈ pentlandite may involve the use of specific techniques or methods, such as cyclic voltammetry or chronoamperometry. These techniques or methods may be selected based on their ability to provide accurate and reliable measurements of the electrochemical activity of the (Fe·Co)₉S₈ pentlandite. The specific techniques or methods used may depend on various factors, such as the specific requirements of the electrochemical measurements and the desired properties of the (Fe·Co)₉S₈ pentlandite.

The following section describe various alternative embodiments of this invention:

Variations in Metal Salts: The method of synthesizing bimetallic (Fe·Co)₉S₈ pentlandite could be modified by using different types of metal salts. For instance, instead of using iron nitrate (Fe(NO₃)₃·9H₂O) and cobalt nitrate (Ni (NO₃)₃·6H₂O), other metal salts such as iron chloride (FeCl₃), cobalt chloride (CoCl₂), iron sulfate (FeSO₄), or cobalt sulfate (CoSO₄) could be used. These alternative metal salts could potentially influence the properties of the resulting (Fe·Co)₉S₈ pentlandite, such as its crystalline structure, morphology, and electrochemical activity.

Variations in Pyrolysis Temperature: The solid-state pyrolysis process could be conducted at different temperatures. Instead of using a temperature of 900° C., other temperatures could be used, such as 800° C., 850° C., 950° C., or 1000° C. The specific temperature used could influence the properties of the resulting (Fe·Co)₉S₈ pentlandite, such as its crystalline structure, morphology, and electrochemical activity.

Variations in Pyrolysis Duration: The duration of the solid-state pyrolysis process could be varied. Instead of conducting the pyrolysis for 10 hours, other durations could be used, such as 8 hours, 9 hours, 11 hours, or 12 hours. The specific duration used could influence the properties of the resulting (Fe·Co)₉S₈ pentlandite, such as its crystalline structure, morphology, and electrochemical activity.

Variations in Dispersing Medium: The (Fe·Co)₉S₈ pentlandite could be dispersed in different types of mediums. Instead of using a Nafion and isopropanol mixture, other mediums could be used, such as a Nafion and ethanol mixture, a Nafion and methanol mixture, or a Nafion and water mixture. The specific medium used could influence the properties of the resulting (Fe·Co)₉S₈ pentlandite, such as its dispersion stability and electrochemical activity.

Variations in Electrochemical Measurement Conditions: The conditions under which the electrochemical activity of the (Fe·Co)₉S₈ pentlandite is measured could be varied. Instead of using 1 M KOH, other concentrations of KOH could be used, such as 0.5 M KOH, 1.5 M KOH, or 2 M KOH. Additionally, other types of electrolytes could be used, such as sodium hydroxide (NaOH) or potassium chloride (KCl). The specific conditions used could influence the measured electrochemical activity of the (Fe·Co)₉S₈ pentlandite.

The bimetallic (Fe·Co)₉S₈ pentlandite described in this disclosure can be used for various applications other than as an electrocatalyst for OER in water splitting for hydrogen production. The sections below describe alternative applications of bimetallic (Fe·Co)₉S₈ pentlandite.

Water Purification Systems: The bimetallic (Fe·Co)₉S₈ pentlandite synthesized through the disclosed method could be used in water purification systems. The electrocatalytic properties of the pentlandite could be utilized to drive electrochemical reactions that break down harmful pollutants in water, such as organic compounds or heavy metals. The high efficiency and stability of the pentlandite could make it a valuable component in water treatment facilities or portable water purification devices.

Energy Storage Devices: The synthesized (Fe·Co)₉S₈ pentlandite could be applied in energy storage devices, such as batteries or supercapacitors. The material's high electrochemical activity could enhance the energy storage capacity and efficiency of these devices. This could be particularly beneficial in the development of renewable energy storage systems, where efficient and cost-effective storage solutions are in high demand.

Fuel Cells: The (Fe·Co)₉S₈ pentlandite could be used as a catalyst in fuel cells, particularly in hydrogen fuel cells. The material's high electrochemical activity towards the oxygen evolution reaction could enhance the efficiency of the fuel cell's operation, potentially improving the overall performance and lifespan of the fuel cell.

Chemical Industry: The method for synthesizing bimetallic ((Fe·Co)₉S₈ pentlandite could be applied in the chemical industry for various reactions that require catalysts. The high catalytic activity and stability of the pentlandite could enhance the efficiency of these reactions, potentially reducing the cost and environmental impact of chemical production processes.

Environmental Monitoring: The (Fe·Co)₉S₈ pentlandite could be used in environmental monitoring devices to detect the presence of specific chemicals or pollutants. The material's electrochemical activity could be utilized to generate a measurable response when exposed to a target substance, providing a means of detecting and quantifying the substance in the environment.

A number of implementations have been described. Nevertheless, it will be understood that various modifications may be made without departing from the spirit and scope of the disclosure. Accordingly, other implementations are within the scope of the following claims.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for synthesizing bimetallic (Fe·Co)₉S₈ pentlandite, the method comprising:
grinding and mixing sulfur powder with metal salts of Fe and Co to form a homogeneous mixture; and
performing solid state pyrolysis of the homogeneous mixture at a temperature of 900° C. in an Argon atmosphere to obtain (Fe·Co)₉S₈ pentlandite.

2. The method of claim 1, wherein the sulfur powder, and the metal salts of Fe and Co have a purity greater than 99.9%.

3. The method of claim 1, wherein the metal salts of Fe and Co are present in an equimolar ratio in the homogeneous mixture.

4. The method of claim 1, wherein the metal salts of Fe and Co include iron nitrate and cobalt nitrate respectively.

5. The method of claim 4, wherein sulfur is ground and mixed together with iron nitrate and cobalt nitrate in a stoichiometric molar ratio of 1.78:1:1 to obtain the homogeneous mixture.

6. The method of claim 1, wherein the metal salts of Fe and Co are a chloride salt or an acetate salt.

7. The method of claim 1, wherein the solid-state pyrolysis is performed in a furnace with controlled temperature ramping rate of 5° C. min⁻¹ until a temperature of 900° C. is achieved.

8. The method of claim 1, wherein the solid-state pyrolysis is performed for 10 hours.

9. A method for synthesizing bimetallic (Fe·Co)₉S₈ pentlandite, comprising:
grinding and mixing sulfur powder with Fe(NO₃)₃·9H₂O and Co(NO₃)₂·6H₂O until a homogeneous mixture is formed; and
conducting a thermal treatment of the homogeneous mixture in a furnace at a temperature of 900° C. under Argon flow for 10 h to obtain (Fe·Co)₉S₈ pentlandite.

10. The method of claim 9, wherein sulfur is ground and mixed together with Fe(NO₃)₃·9H₂O and Co(NO₃)₂·6H₂O in a stoichiometric molar ratio of 1.78:1:1 to obtain the homogeneous mixture.

11. The method of claim 9, wherein the grinding and mixing of sulfur powder with Fe (NO₃)₃·9H₂O and Co(NO₃)₂·6H₂O is performed in a ball mill.

12. The method of claim 9, wherein the grinding and mixing of sulfur powder with Fe(NO₃)₃·9H₂O, Co(NO₃)₂·6H₂O is performed using a mechanical mixer at a speed of 500 rpm.

13. The method of claim 9, wherein the thermal treatment is performed in a furnace with controlled temperature ramping rate of 5° C. min⁻¹ until a temperature of 900° C. is achieved.

14. The method of claim 9, wherein prior to thermal treatment the homogenous mixture is loaded in a porcelain alumina boat to be placed in the furnace to avoid chemical contamination.

15. A method for synthesizing an electrode comprising bimetallic (Fe·Co)₉S₈ pentlandite, the method comprising:
grinding and mixing sulfur powder with metal salts of Fe and Co to form a homogeneous mixture;
performing solid state pyrolysis of the homogeneous mixture in a furnace at a temperature of 900° C. for 10 hours to obtain (Fe·Co)₉S₈ pentlandite;
dispersing the (Fe·Co)₉S₈ pentlandite in a Nafion and isopropanol mixture to form a suspension; and
coating the suspension on a glassy carbon electrode to form an electrode comprising the (Fe·Co)₉S₈ pentlandite.

16. The method of claim 15, wherein the metal salts of Fe and Co include iron nitrate and cobalt nitrate mixed in an equimolar ratio.

17. The method of claim 15, wherein the grinding and mixing of sulfur powder with metal salts of Fe and Co is performed in a ball mill.

18. The method of claim 15, wherein the Nafion and isopropanol mixture comprises 5% Nafion and the remainder being isopropanol.

19. The method of claim 15, wherein dispersing the (Fe·Co)₉S₈ pentlandite in a Nafion and isopropanol mixture is performed using a sonicator operates at a power of 100 W and a frequency of about 42 kHz.

20. The method of claim 15, wherein coating the suspension on a glassy carbon electrode is performed by at least one of drop casting, dip coating or spray coating.
